(19) United States
(12) Patent Application Publication
(10) Pub. No.: US 2024/0355561 A1
(43) Pub. Date: Oct. 24, 2024

(54) SAFETY SWITCH FOR GUARDING ACCESSES TO MACHINES OR INDUSTRIAL PLANTS AND RELATED ASSEMBLY

(71) Applicant: PIZZATO ELETTRICA S.R.L., Marostica (IT)

(72) Inventors: Marco PIZZATO, Marostica (IT); Simone ZONTA, Bassano del Grappa (IT)

(21) Appl. No.: 18/638,824

(22) Filed: Apr. 18, 2024

(30) Foreign Application Priority Data
Apr. 18, 2023 (IT) 102023000007563

(51) Int. Cl. H01H 27/00; F16P 3/08; H01H 1/58; H01H 9/16

(52) U.S. Cl. CPC H01H 27/002; F16P 3/08; H01H 1/5805; H01H 9/167; H01H 2223/03

(57) ABSTRACT

A safety switch for guarding accesses to industrial machines or plants comprises a case which extends along a main dimension defining a longitudinal axis of development, control means housed in the case and suitable for receiving and exchanging signals with the actuating device and/or with the machine or plant and provide with a first PCB, a head connected to the case and adapted to interact with the actuating device upon the opening/closing of the access and wherein the first PCB comprises a first longitudinal portion housed in the case and a second longitudinal portion housed in the head.

### TECHNICAL FIELD

The present invention finds application in the filed electrical devices for industrial use, in particular for the control of industrial machines and plants, and particularly relates with a safety switch suitable, for example, for the protection of access to safety perimeters or areas for industrial machines or plants.

The invention also relates with a safety assembly for guarding accesses which comprises the above safety switch and an actuating device suitable to cooperate therewith upon the opening/closing of the access and the locking/unlocking thereof.

### STATE OF THE ART

As known, safety assemblies for the control of industrial machines and systems generally comprise a first switching device having the function of a safety switch for switching the power and/or service circuits of the machine or plant, or of parts thereof, suitable to cooperate with a second device having a driving function and which interacts with the first device to generate a command for switching the above circuits.

For safety assemblies designed to guarding accesses to safety perimeters or working areas of industrial machines or plants, the safety switch is usually applied to a fixed part of the protection close to the access.

Instead, the actuating device is generally applied directly to the movable part of the access, so that the interaction with the switching device occurs when the access is closed, according to operating schemes that may vary according to multiple schemes.

A particular type of such assemblies is represented by electronically operated assemblies, wherein the switching device or safety switch is provided with a first communication element, usually an antenna, suitable of communicating with a second communication element, such as a transponder, associated with the movable element, for example the actuating device or an element of the machine to be detected, to receive a coded presence signal suitable for indicating the proximity of the movable element.

Generally speaking, safety switches comprise a main module provided with a case which houses thereinside both the mechanical or electronic switching elements, with the relative connection terminals of the circuits to be controlled, and, for safety switches for guarding accesses, also a mechanism for locking the actuating device, i.e. a mechanism suitable for engaging the actuating device to prevent the unsafe opening of the access.

The safety switch is completed by one or more auxiliary modules, among which there is generally a head designed to allow interaction between the actuating device and its locking mechanism.

With electronically operated switches, the head may also house the antenna or other appropriately provided remote communication element.

Inside the case there is usually a PCB (Printed Circuit Board) on which two safety CPUs are typically applied for controlling the switching elements and the various electronic circuits necessary for the management of the signals and commands transmitted or received from other devices of the plant or machine in which the switch is located.

In known solutions, the PCB, together with the several circuit components, is arranged entirely inside a space defined by the case and arranged adjacent, typically below, to the switch head.

Although this configuration is very widespread in the field, it necessarily implies that the overall longitudinal size of the safety switch is at least equal to the longitudinal size of the PCB, plus the longitudinal size of the head.

Moreover, this overall longitudinal size has also to consider the screws, or other equivalent elements, for fixing the head to the case, which pass through the head in the longitudinal direction of the switch and enter the case.

These elements represent limits for the miniaturization of the safety switches which, to date, typically have a longitudinal dimension of no less than approximately 15 cm.

This condition is particularly problematic in those industrial machines wherein a safety switch that is too bulky could interfere with the correct closing of the access, making the machine potentially dangerous for the operator.

Furthermore, in some cases it is necessary to connect the PCB through appropriate wiring to the various electrical and/or electronic devices present in the switch, such as the above cited communication elements, or lights or other luminous and/or acoustic signaling devices, which may be located on the case or even on the head, as for the switch described in WO2022185266.

However, when the electrical and/or electronic components are housed in the head, their connection to the PCB requires that the wiring extends from the case to the head, i.e. between two modules which are generally distinct from each other, at least during assembly of the complete device, and which can also be orientable with respect to each other according to different configurations, for example by relative rotation of the head with respect to the longitudinal axis of the case.

This results in greater complexity of the wiring and greater difficulty in assembly.

A further drawback, for devices electronically operated wherein there is interaction between an antenna placed in the head with the transponder of the actuating device, is represented by the need to provide multiple antennas, for example three antennas, in order to guarantee correct communication between the switching device and the actuating device whatever the position of the head with respect to the case, i.e. even following the rotation of the first with respect to the second.

This configuration inevitably also involves the use of solutions that are bulkier and therefore more difficult to install due to the need to have sufficiently large anchoring spaces.

### SCOPE OF THE INVENTION

The object of the present invention is to overcome the above drawbacks by providing a safety switch for guarding accesses to industrial machines or plants which has features of high efficiency and relative cost-effectiveness.

A particular object is to provide a safety switch for guarding accesses to industrial machines or plants which allows the entire electronics, or even part of it, to be inserted easily inside the head both during production and assembly and which does not require complex wiring, to also guarantee increased reliability.

Yet another particular object is to provide a safety switch for guarding accesses to industrial machines or plants, in particular of the electronically operated type, which uses a reduced number of components, while at the same time guaranteeing the necessary functionality and configurability of the device.

Yet another particular object is to provide a safety switch for controlling access to industrial machines or plants which is particularly compact and has a reduced overall longitudinal size compared to known solutions.

These objects, as well as others that will become more apparent hereinafter, are achieved by a safety device for guarding accesses to industrial machines or plants which, according to claim 1, comprise a case extending along a main dimension defining a longitudinal development axis, control means housed in said case and suitable for receiving and exchanging signals with the actuating device and/or with the machine or plant and provided with a first PCB, a head connected to said case and adapted to interact with the actuating device upon the opening/closing of the access and wherein said first PCB comprises a first portion housed in said case and a second portion housed in said head.

In this way, the connection between the electrical and/or electronic components housed in the head, such as an RFID antenna, LED signaling lights or other detection and signaling means appropriately designed according to needs, with control devices located on the PCB, such as, again by way of example, CPUs or switching means, will be significantly simplified.

Preferably but not exclusively, the head may comprise a connection portion to said case having a seat for housing said second portion of said first PCB and L-shaped with a longitudinal arm extending from the upper face of the case and a transverse arm cantilevered from said longitudinal arm.

Furthermore, there will be detection and signaling means connected to said control means and suitable for detecting the presence of the actuating device and signaling the condition of the access. In particular, said detection and signaling means may comprise a first remote communication element, such as an antenna, housed in said transversal arm and suitable for detecting the presence of an electronic actuator device through the exchange of a signal presence with a second communication device associated with the actuating device.

This particular configuration will allow to insert a single antenna, or equivalent communication element, inside the head, which can be placed in a substantially central position and which will always be aligned axially with the communication element of the actuating device, once the actuating pin will be inserted into the head, according to known methods which will be described more clearly later.

Advantageous embodiments of the invention are obtained in accordance with the dependent claims.

### BRIEF DISCLOSURE OF THE DRAWINGS

Further features and advantages of the invention will become more apparent in light of the detailed description of preferred but not exclusive embodiments of the safety switch and of an assembly comprising such a switch, shown by way of non-limiting example with the aid of the attached drawing tables wherein:

FIG. 1 is an exploded and simplified side view of the switch;

FIG. 2 is a front view of the assembled switch of FIG. 1;

FIG. 3 is a perspective view of the assembly equipped with the switch according to the invention and with the actuating device not inserted;

FIG. 4 is an assembled perspective view of the switch of FIG. 3;

FIG. 5 is an exploded perspective view of the switch of FIG. 4;

FIG. 6 is a front view of the switch of FIG. 4;

FIG. 7 is a front-rear view of the switch of FIG. 4;

FIG. 8 is a side sectional view of the switch of FIG. 3;

FIG. 9 is a sectional view of the switch of FIG. 3 according to the A-A trace plane of FIG. 8;

FIG. 10 is a sectional view of the switch of FIG. 3 according to the B-B of FIG. 8;

FIG. 11 is a perspective view of a detail of the switch of FIG. 3 which shows the case and the head without the upper element in an unassembled condition;

FIG. 12 is a side sectional view of the detail of FIG. 11 in the unassembled condition;

FIG. 13 is an enlarged and sectional view of a detail of the switch;

FIG. 14 is a front view of an element of the detail of FIG. 11;

FIG. 15 is a rear view of the element of FIG. 14;

FIG. 16 is a sectional side view of the assembly of FIG. 3 wherein the actuating device is inserted into the switch.

### BEST MODES OF CARRYING OUT THE INVENTION

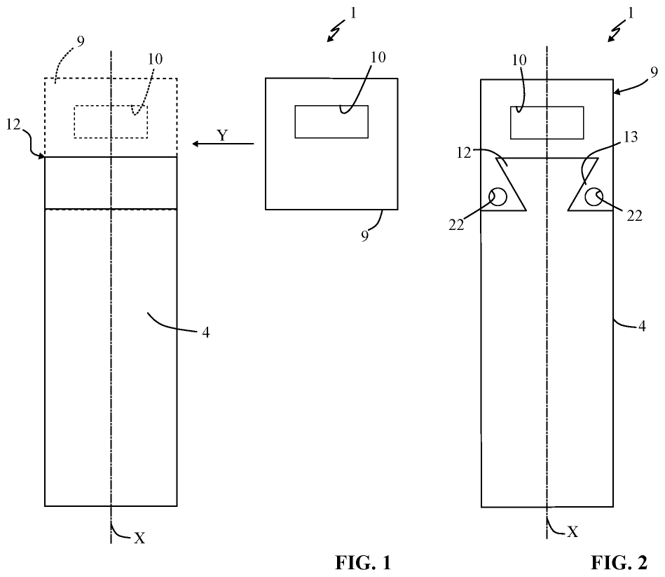

FIGS. 1 and 2 schematically illustrate a simplified embodiment of a safety switch, globally referred as 1, for guarding accesses to industrial machines and plants.

In particular, the shown switch is of the type designed to be anchored to a fixed or movable part of a perimeter, panel or safety barrier close to an access to a working area wherein an industrial machine or plant is located, to monitor this access.

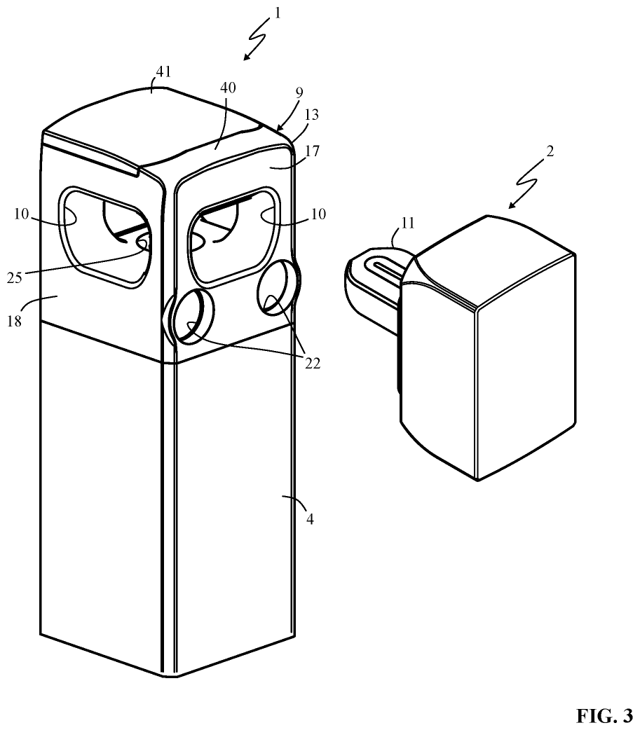

In a known manner, the safety switch 1 is designed to be mounted close to the access to be monitored to interact with an actuating device, an example of which is illustrated in FIG. 3 and globally referred as 2, upon the opening/closing or the unlocking of the access, as described in more detail below.

For example, the safety switch 1 may be anchored to the fixed part of an access, such as the frame of a door, while the actuating device 2 may be anchored to the movable part of the access, or vice versa.

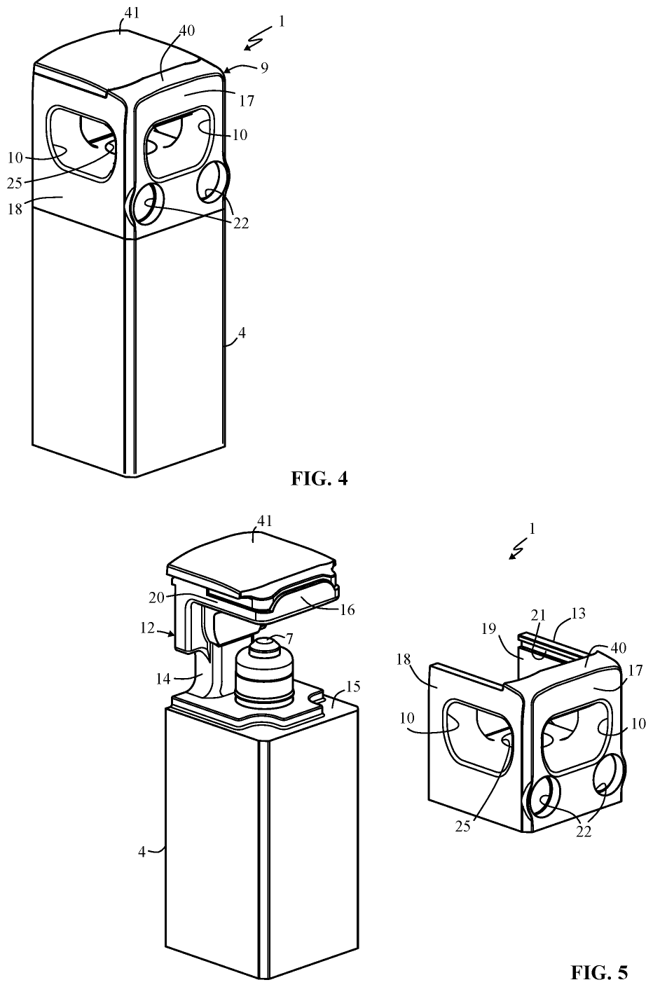

As visible in FIG. 4, the above safety switch 1 is shown without the actuating device 2, in its most essential configuration, the safety switch 1 comprises a case 4 housing switching means suitable for being connected to the control means of the machine or plant, such as one or more power and/or service circuits and/or to safety control devices of the machine, such as safety modules or PLCs, depending on the type of switching means adopted.

The switching means may be designed to signal the status of the access guarded by the safety switch 1 and, for example, may signal whether the access is open or closed or closed and locked. The switching means, not shown in the figures as known per se, may generally comprise one or more pairs of mutually movable contacts suitable for opening and closing respective circuits upon the reception of specific commands and/or signals, according to known schemes not described here as they do not represent a limitation for the present invention.

Alternatively, or in addition, the switching means may be of the electronic OSSD (Output Signal Switching Device) type and comprise semiconductor devices or one or more transistors, to be connected to the above safety modules or PLCs.

It is understood that the technical properties of the switching means do not represent a limiting aspect for the present invention.

The case 4 develops along a main dimension defining a longitudinal axis of development L and also houses inside it a locking/unlocking mechanism 5, described in more detail below but whose configuration is not to be understood as limiting the present invention.

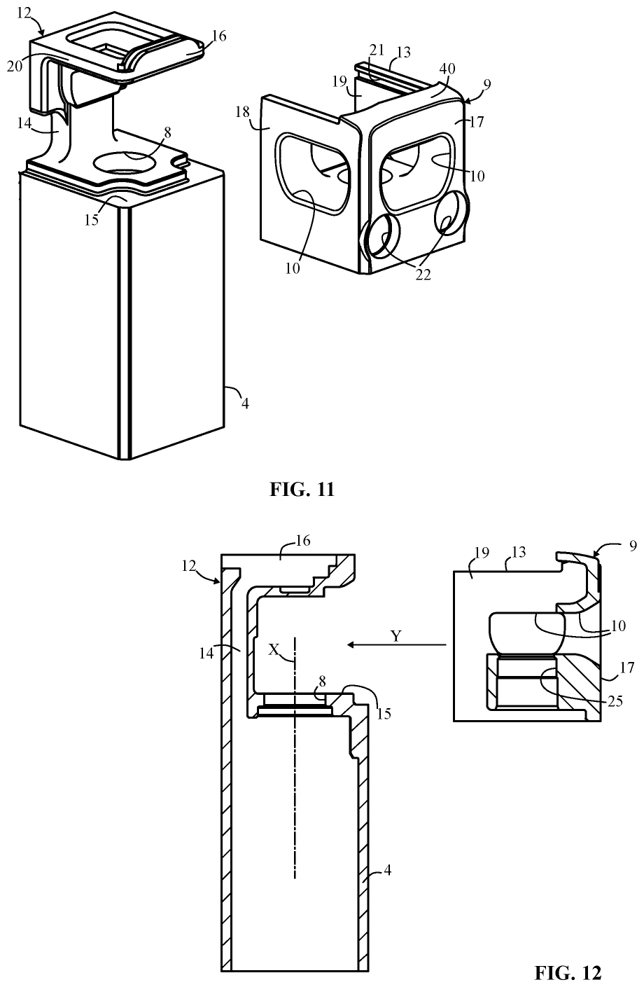

In particular, the main task of the locking/unlocking mechanism 5 will be to lock the actuating device 2 with respect to the safety switch 1 and for this purpose it may be provided with a locking/unlocking pin 6 movable in the case 4 along a longitudinal direction X to protrude at least partially with one of its ends 7 outside the case 4, as visible in FIG. 5, through an upper passage 8 made in the case 4 and visible in FIG. 11.

The safety switch 1 is then provided with a head 9 fixed on the case 4 and which is designed to allow the interaction of the locking/unlocking pin 6 with the actuating device 2.

In particular, the head 9 may be provided with one or more slots 10 suitable to allow the interaction of the locking/unlocking pin 6 with an actuator pin 11 protruding from the actuating device 2.

In particular, the slots 10 will allow the actuator pin 11 to enter at least partially into the head 9 to be blocked with respect to the safety switch 1 following the retention action of the locking/unlocking pin 6.

In particular, the slots 10 will define respective insertion directions Z of the actuator pin 11 inside the head 9.

The actuator pin 11 may have a retention and centering function or even may operate as actuator, depending on the type of actuating device.

However, it will also be possible to have solutions wherein the head 9 is free of slots or similar elements, for example if the actuating device 2 is not provided with an actuator pin or other mechanical or electromechanical actuator, as for example in some switch solutions with totally electronic actuator like the one described in WO2015/155744, in the name of the same Applicant. In these cases the safety switch 1 may also be devoid of the locking/unlocking mechanism 5.

Optionally, the safety switch 1 may be implemented with further auxiliary modules, such as, for example, modules provided with emergency controls, manual release, connection modules, even of different types to allow connection with different types of cables, or other types of modules according to typical configurations for this type of product.

According to the embodiments of the figures, which are illustrative and non-limiting for the present invention, the head 9 and the case 4 are mutually coupled by respective mutual coupling means suitable to allow their mutual stable fixing by mutual sliding along at least one sliding direction Y transversal to the longitudinal direction X.

However, it is understood that the methods of coupling between the case 4 and the head 9 may also be of a different type from those illustrated, or the case 4 and the head 9 may be monolithic with each other.

Generally speaking, in the illustrated embodiments, the mutual coupling means will comprise a first coupling element 12 integral with the case 4 and a second coupling element 13 integral with the head 9.

Furthermore, the two coupling elements 12, 13 comprise mutually counter-shaped coupling portions to allow their coupling by sliding along the sliding direction Y.

In the example of FIGS. 1 and 2 the two coupling elements 12, 13 are shaped to define a dovetail coupling.

Preferably, the sliding direction Y will be orthogonal to the longitudinal direction X, as schematized in FIG. 1.

Even more preferably, the sliding direction Y corresponds or is parallel with one of the insertion directions Z defined, in use, by the slots 10 and along which the actuator pin 11 moves inside the head 9.

In the preferred configuration of the figures, as more clearly visible in FIG. 5, the mutual coupling means comprise a retaining body 12 integral with the case 4 and which will define the first coupling element.

Instead, the head 9 will be provided with a removable portion 13 defining the second coupling element and which will be adapted to be coupled to the retaining body 12 by transversal sliding along the sliding direction Y.

The retaining body 12 will be suitably shaped to define a constraint for the removable portion 13 of the head 9 with respect to the case 4 at least along the longitudinal direction X, in both directions therealong.

In other words, the retaining body 12 limits, or more preferably blocks, the mutual sliding between head 9 and case 4 along the longitudinal direction X in both directions.

Even more preferably, the retaining body 12 will be suitably shaped to define a constraint for the head 9 with respect to the case 4 also along the sliding direction Y, limiting, or more preferably blocking, the mutual sliding between the head 9 and the case 4 along the sliding direction Y, in at least one direction.

Even more preferably, the retaining body 12 will be suitably shaped to define a constraint for the head 9 with respect to the housing 4 also along a direction perpendicular to the longitudinal direction X and to the sliding direction Y.

In the preferred embodiments, the retaining body 12 will be suitably L-shaped, i.e. with a longitudinal arm 14 extending from the upper face 15 of the case 4, or the one provided with the upper passage 8 for the locking/unlocking pin 6, and a transverse arm 16 cantilevered from the upper end of the longitudinal arm 14.

In the preferred embodiments, the transverse arm 16 extends at a level, with respect to the longitudinal direction X, located close to the level of the upper end 40 of the removable portion 13. More specifically, the transverse arm 16 covers, completely or partially, or is coplanar with the upper end 40 of the removable portion 13. In this way the removable portion 13 is predominantly interposed between the upper face 15 of the case 4 and the transverse arm 16 which, therefore, prevent the movement of the removable portion 13 along the longitudinal direction X.

In turn, the removable portion 13 of the head 9 will be shaped to surround the retaining body 12 on at least three sides and define with it a head 9 with a substantially prismatic shape, for example approximately in the shape of a cube or parallelepiped as in the figures.

In particular, the removable portion 13 will have a front face 17 and a pair of side faces 18, 19, on at least one, preferably at least two, of which a slot 10 will be provided for the insertion of the actuator pin 11 of the actuating device 2.

The retaining body 12 and the removable portion 13 comprise respective coupling portions with conjugated shape designed to define a shaped coupling therebetween.

The transverse arm 16 will be provided with transversal sliding guides 20 adapted to slidably engage respective transversal sliding counter-guides 21 made on each of the two side faces 18, 19. It is understood that the sliding coupling between the removable portion 13 and the retaining body 12 may also be obtained with different coupling systems, for example with joints or other couplings of the male and female type, without particular limitations.

The head 9 will also be shaped to allow the insertion and consequent longitudinal movement within it of the protruding end 7 of the locking/unlocking pin 6, to allow its interaction with the actuator pin 11.

According to a further particularly advantageous aspect, in a preferred but not exclusive configuration, the retaining body 12 will be monolithic with the case 4 and possibly made of one piece with the same and in the same material.

By way of example, the retaining body 12 and the case 4 may be obtained by means of a single mechanical processing operation, such as moulding.

Optionally, it will be possible to make the case 4 and the retention body 12 in plastic material, while the removable portion 13 of the head 9 may be made of metallic material to guarantee adequate resistance to interactions with the actuating device 2 and to efficiently withstand the stresses transmitted both by the actuating device 2 and by the constraint produced by the anchoring means to the fixed frame of the protection or to another fixed or movable part of the access.

This conformation will make the safety switch 1 light and economical but at the same time resistant.

In particular, the above firm anchoring means of the safety switch 1 may be associated exclusively with the head 9, and even more preferably only with the removable portion 13.

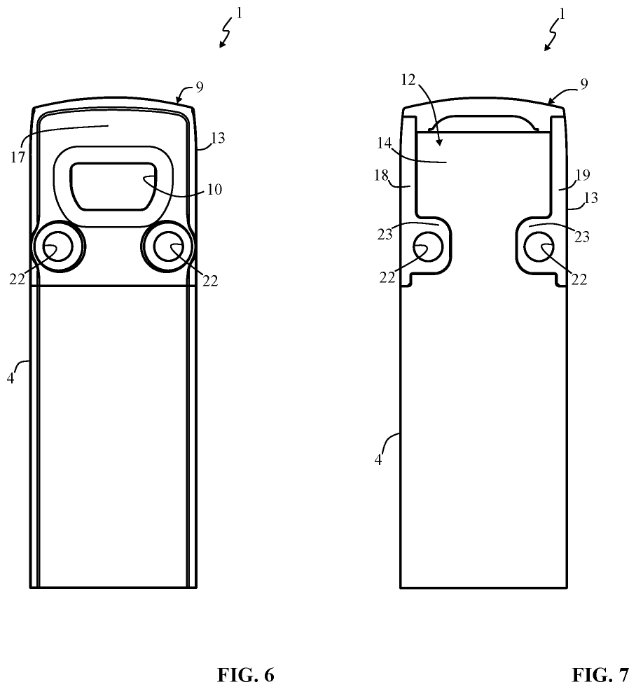

As more clearly visible from the front view of FIG. 6, the anchoring means may comprise one or more anchoring through holes 22, for example a pair of anchoring through holes 22, which extend parallel to each other along a direction transverse to the longitudinal direction X.

Preferably, the anchoring through holes 22 will extend along a direction parallel to the sliding direction Y or orthogonal to this and also to the longitudinal direction X.

The anchoring through holes 22 will be made in at least one between the front face 17 and the side faces 18, 19 of the removable portion 13 of the head 9, for example on the front face 17 as in the figures, and laterally to the longitudinal arm 14.

As visible from FIG. 7, the removable portion 13 will also be provided with a pair of rear appendages 23 which will be arranged, upon complete assembly, in a coplanar position with the longitudinal arm 14 and which will have respective outlets of the anchoring through holes 22. This particular embodiment of the anchoring means will allow the head 9 to be firmly locked with respect to the case 4 at the same time as the entire safety switch 1 is fixed to the access, without using further fixing means between the head 9 and the case 4.

So, the coupling between the head 9 and the case 4 may be of a completely removable type, obviously in the event that the safety switch 1 is not fixed in position by the anchoring means. Alternatively, the mutual coupling means may also comprise constraint elements suitable for making the coupling between head 9 and case 4 completely blocked or only partially modifiable.

For example, the constraint means may be designed to only partially block the coupling between head 9 and case 4 and make the head 9 orientable with respect to the case 4, while still constraining the former with respect to the latter along the transverse direction Y.

Preferably, the constraint means may be designed to completely block the movement of the head 9 with respect to the case 4 or to limit it to a predetermined maximum stroke, avoiding complete detachment.

This configuration will have the purpose of preventing the end user from dismantling the safety switch 1.

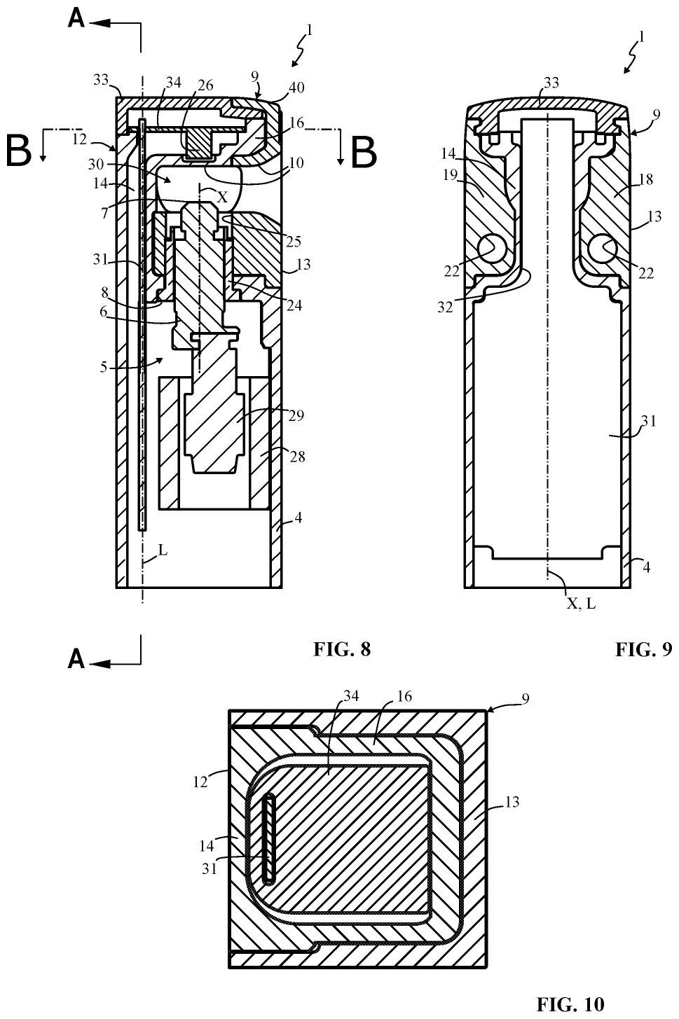

In a preferred configuration, shown in FIG. 8, the constraint means comprise an anchoring bush 24 coaxial to the locking/unlocking pin 6 and which will be inserted into the longitudinal passage 25 of the removable portion 13. The anchoring bush 24 is suitable to define a constraint along the transverse direction Y between the removable portion 13 and the case 4.

According to a first variant, the safety switch 1 may be of the electronically operated type and, in this case, it will be designed to communicate with the actuating device 2 through the exchange of an electromagnetic presence proximity signal, preferably of a coded type, as described more clearly below.

From the same FIG. 8 it can also be observed that the safety switch 1 will also be provided with a first PCB (Printed Circuit Board) 31 housed in the case 4 and associated with a control unit suitable of controlling the switching means, receiving and exchange signals with the actuating device 2 and/or with the machine or plant.

Preferably, on the first PCB 31 there may be both the control unit, for example comprising one or more CPUs (Central Processing Unit) and the switching means, preferably of the OSSD type.

Even more preferably, the control unit comprises two CPUs configured to communicate with each other in a redundant manner and the switching means comprises two safe outputs, each of which is controlled by a respective of said two CPUs of the control unit.

The first PCB 31 may also comprise electrical and electronic circuits for communication of the control unit with external command and control systems, such as for example safe communication BUS (Profisafe, IOlink safety, CIP Safety and similar) and not safe (Profinet, IOlink, EthrNet/IP, Profinet and similar) and for the management of the various components, including any LED lights or other signaling elements.

According to a further particularly advantageous aspect, the first PCB 31 will extend longitudinally inside the case 4 and also inside the head 9.

In particular, the first PCB 31 comprises a first longitudinal portion housed inside the case 4 and a second longitudinal portion housed inside the head 9.

From FIG. 9, wherein the PCB 31 is shown frontally, it is possible to note as the PCB 31 has a large section inside the case 4 and a narrow section inside the head 9.

Preferably, the two longitudinal portions of the first PCB 31 will be integral and in physical continuity with each other.

To this end, the upper face 15 of the case 4 will be provided with at least one opening or slot 32 for the passage of the first PCB 31 inside the head 9.

In this way, the first PCB 31 will be contained in a development plane parallel to the longitudinal axis of development L of the case 4 and, furthermore, it will extend in a lying plane intersected by a plane perpendicular to the longitudinal axis X and containing insertion directions Z defined by the slots 10.

This configuration will allow to have a safety switch 1 with a particularly compact structure and reduced overall height compared to similar solutions.

FIG. 11 and FIG. 12 show according to two respective and distinct views the way of assembling the safety switch 1 of FIG. 3.

FIG. 14 and FIG. 15 show respectively the front and the rear of the case 4 of the above safety switch 1.

The head 9 may also house detection and signaling means connected to the control means and suitable to detect the presence of the actuating device 2 and signaling the opening/closing/unlocking status of the access.

By way of example, the detection and signaling means may first of all comprise a first communication element 26 of the receiving or transmitting type, suitable for communicating with a second communication element 27 of the transmitting or receiving type associated with the actuating device 2.

Generally, the receiving element will be an RFID (Radio Frequency Identification) type antenna or reader configured to communicate with the transmitting element, which may instead be a transponder, when the latter is at the minimum detectable distance from the antenna or reader.

In the example of FIG. 14, the first communication element 26 is a receiving element, for example of the RFID type, and the second communication element 27 is a transmitting element, such as a transponder.

In particular, the RFID type receiving element will emit a signal capable of exciting the transponder, which is in turn equipped with an RFID tag with identification code, which in turn will emit a response signal which will be received by the receiving element and which has to be recognized by the control means of the safety assembly, appropriately equipped with a CPU, to allow the machine or plant to be started.

Advantageously, the first communication element 26, preferably an RFID type antenna, will be housed in the transverse arm 16 to detect the presence of an electronic actuating device 2 by exchanging a proximity signal with the second communication device 27, preferably a transponder, associated with the actuating device 2.

More precisely, in the illustrated configuration, the second longitudinal portion of the first PCB 31 will be placed in the longitudinal arm 14 of the retaining body 12, to connect directly to the first communication element 26 housed in the transverse arm 16.

The detection and signaling means housed in the transverse arm 16 also comprise one or more signaling lights or indicators, generally of the LED type, not shown, connected to the control unit and whose color and/or frequency may vary based on the operative condition of the access and/or circuits of the machine or plant to which they are connected.

Advantageously, the head 9 may also be provided with an upper portion or cap 33. In this case, the transverse arm 16 comprises a cap 33 made of a transparent or translucent material and which encloses therewithin at least part of the detection and signaling means, i.e. the above lights or indicator or other sources of light signals, which will thus be visible, at least in the ON condition, through the cap 33.

According to the exemplifying but not limiting embodiment of the figures, the cap 33, which will also have the function of a lens, will preferably be applied to the upper face of the head 9, substantially along its whole development surface, in a fixed or removable manner, for example if desired intervene on the warning lights.

The positioning of the cap 33 on the upper face of the head 9 will allow the visibility of the warning lights even if the operator is not positioned frontally with respect to the switch 1.

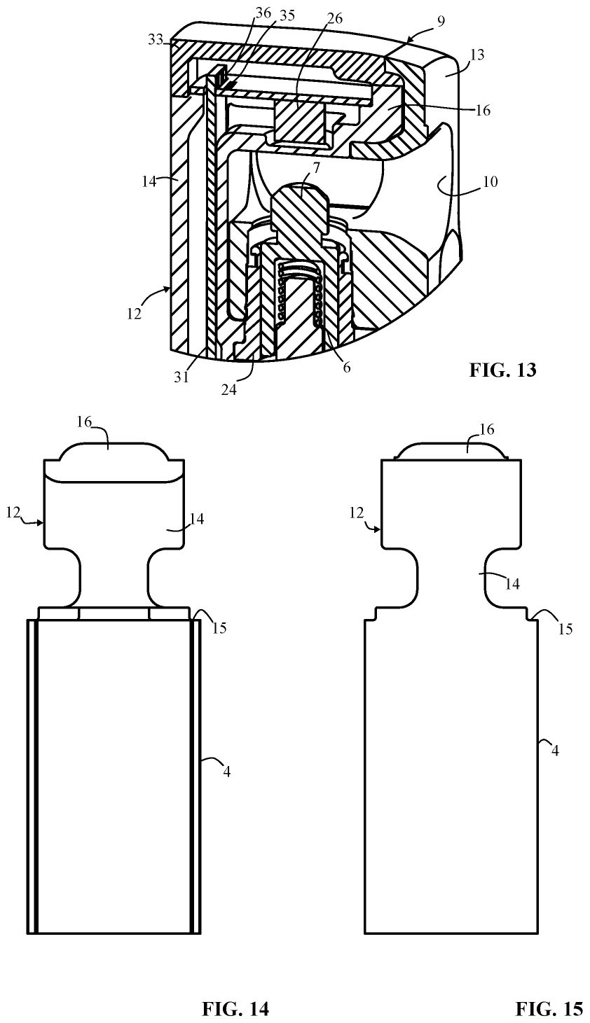

As more clearly visible from FIGS. 10 and 13, the transverse arm 16 of the retaining body 12 houses a second PCB 34 which supports the detection and signaling means, i.e. the part of these means housed in the head 9.

Preferably, the second PCB 34 will be connected to the second longitudinal portion of the first PCB 31 and will be provided with one or more electrical connection tracks 35 connected to corresponding electrical connection tracks 36 of the first PCB 31 for the electrical connection between the detection and signaling means and the control unit.

Preferably, the connection tracks 36 of the first PCB 31 may be welded to the connection tracks 35 of the second PCB 34.

However, it will also be possible to provide alternative embodiments wherein the electrical continuity between the connection tracks 35, 36 may be obtained by means of electrical connectors of any kind.

Always in FIG. 13, it can also be observed that the first communication element 26, hereinafter also antenna 26, extends from the second PCB 34, below it, in such a position as to be aligned with the locking/unlocking pin 6.

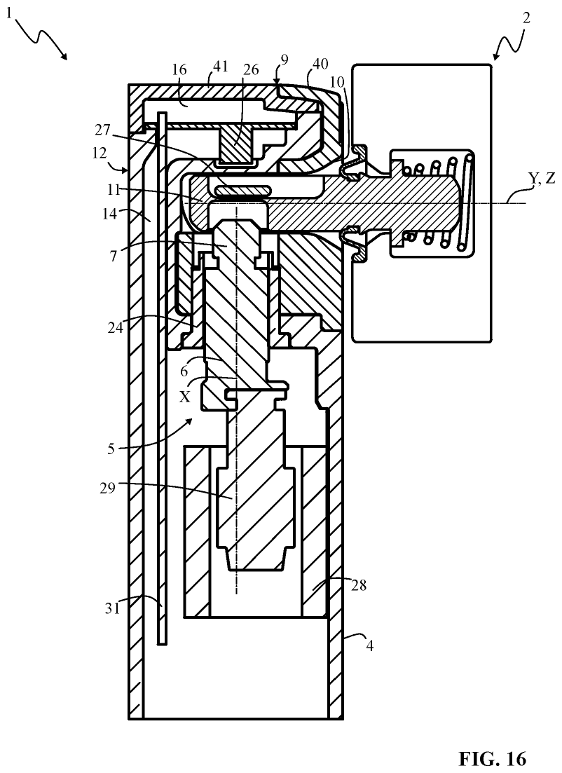

FIG. 16 shows an electronically operated safety assembly wherein the safety switch 1 is provided with the antenna 26 and the actuating device 2 is provided with the transponder 27.

In particular, the transponder 27 may be provided with an RFID tag with an identification code which will be received by the antenna 26 and which must be recognized by the control unit in order to allow the machine or plant to be started.

Code recognition may be unique or generic, depending on whether you want to create a safety switch with a high or low coding level.

Advantageously, the RFID tag will be coded so that it can be uniquely recognized by the antenna 26, preventing the use of actuating devices other than the one connected to the access, avoiding the risk of unsafe opening of the access.

Optionally, the recognition of the RFID tag by the antenna 26 will allow the activation of the locking/unlocking mechanism 5.

From the same section it is also possible to observe a possible embodiment of the locking/unlocking mechanism 5, provided with an electromagnet 28 suitable to be energized/deactivated to promote the longitudinal translation, in one or the other sense, of a pusher 29 connected mechanically to the locking/unlocking pin 6.

Consequently, the locking/unlocking pin 6 will move along the longitudinal direction X, according to known methods in the sector and therefore not described in greater detail.

Briefly, upon the energization or de-energization of the electromagnet 28, the locking/unlocking pin 6 may translate in a first sense along the longitudinal direction X so that its upper end 7 fits into the seat 30 of the head 9 designed to house the actuator pin 11, blocking the latter with respect to the head 9, or it may translate in the opposite sense, always along the longitudinal direction X, to remove the upper end 7 from the seat 30, so as to allow the extraction of the actuator pin 11 and the unlocking of the access.

The electromagnet 28 may be replaced in a completely equivalent manner by another electromechanical, electric, hydraulic or pneumatic actuating means housed in the case 4.

The first communication element 26 may be housed inside the transverse arm 16 of the retaining body 12, so as to face the protruding end 7 of the locking/unlocking pin 6 and detecting the presence of the second communication element 27 when inserted in the seat 30 of the head 9.

Conveniently, the second communication element 27 will instead be inserted into the actuator pin 11 which fits into the seat 30 of the head 9.

It has to be understood that the communication elements 26, 27 may also be of another type, for example magnetic or electromagnetic, optical, mechanical, inductive, pressure operated or other types.

According to a not shown variant, the safety switch may be of the electromechanically operated type and interact with an actuation device equipped with a key actuator in place of the retention and centering pin, according to known methods described for example in EP0871188.

The safety switch 1 according to the present invention will be suitable for use within a safety system for the control of a plant machine and which comprises one or more safety switches associated with respective accesses to be guarded, not necessarily identical between them nor all of them in accordance with the present invention, and suitable for interacting with respective actuating devices. The system will then comprise one or more safety modules or PLCs designed to manage the power supply of the machine or system based on the signals exchanged with the switch.

1. A safety switch for guarding accesses to industrial machines or plants suitable for being mounted close to an access to interact with an actuating device at the opening/closing of the access, which safety switch comprises:
a case which extends along a main dimension defining a longitudinal axis of development;
control means housed in said case and adapted to receive and exchange signals with the actuating device and/or with the machine or plant and provided with a first PCB;
a head connected to said case and adapted to interact with the actuating device upon the opening/closing of the access;
wherein said first PCB comprises a first longitudinal portion housed in said case and a second longitudinal portion housed in said head.

2. The safety switch as claimed in claim 1, wherein said first longitudinal portion and said second longitudinal portion of said first PCB are integral and in physical continuity with each other.

3. The safety switch as claimed in claim 2, wherein said head comprises a coupling element for the connection of said head with said case, said coupling element being integral with the upper face of said case and shaped to house said second portion of said first PCB, said upper face of said case being provided with at least one opening or slot for the passage of said first PCB in said head.

4. The safety switch as claimed in claim 3, wherein said coupling element is L-shaped and has a longitudinal arm extending from said upper face of said case close to said opening or slot and a transverse arm cantilevered from said longitudinal arm.

5. The safety switch as claimed in claim 4, wherein said first PCB extends in said case along a direction parallel to said longitudinal axis of development.

6. The safety switch as claimed in claim 1, comprising detection and signaling means connected to said control means and suitable for detecting the presence of the actuating device and for signalling the status of the access and/or of the machine or plant.

7. The safety switch as claimed in claim 6, wherein said detection and signaling means comprise a first remote communication element housed in said transverse arm and adapted to detect the presence of an actuating device of the electronic type by exchanging a proximity signal with a second communication element associated with the actuating device.

8. The safety switch as claimed in claim 7, wherein said first communication element is an antenna adapted to detect RFID signals.

9. The safety switch as claimed in claim 8, wherein the detection and signaling means housed in said transverse arm comprise one or more signaling lights or indicators.

10. The safety switch as claimed in claim 9, wherein said transverse arm of said head houses a second PCB which supports at least part of said detection and signaling means.

11. The safety switch as claimed in claim 10, wherein said second PCB is provided with one or more electrical connection tracks connected to corresponding electrical connection tracks of said first PCB for the connection between said detection and signaling means and said control means.

12. The safety switch as claimed in claim 10, wherein said second PCB is fastened to said second longitudinal portion of said first PCB.

13. The safety switch as claimed in claim 3, wherein said head comprises a removable portion having coupling means for coupling with said coupling element.

14. The safety switch as claimed in claim 1, adapted to interact with an actuating device provided with an actuator pin, wherein said case houses a locking/unlocking mechanism for locking/unlocking the actuating device and provided with a locking/unlocking pin movable along a longitudinal direction to protrude at least partially with one end from said case inside said head, said head having one or more slots suitable for allowing the insertion of the actuator pin.

15. The safety switch as claimed in claim 14, wherein said one or more slots are made on said removable portion of said head.

16. The safety switch as claimed in claim 14, wherein said one or more slots define respective insertion directions of the actuator pin inside said head, said first PCB being intersected by a plane perpendicular to said longitudinal axis of development and containing said insertion directions.

17. A safety assembly for guarding accesses to industrial machines or plants, comprising a safety switch according to claim 1 adapted to be anchored to one between a fixed part and a movable part of the access to be guarded and an actuating device adapted to be anchored to the other between the fixed or movable part of the access to be guarded and adapted to interact with said safety switch upon the closing/opening of the access for the opening/closing of one or more power and/or service circuits of the machine or plant.
